(19) United States
(12) Patent Application Publication
(10) Pub. No.: US 2010/0283997 A1
(43) Pub. Date: Nov. 11, 2010

(54) Test device, system and method for optic fiber cable connections

(75) Inventor: Kevin Lu, Taipei City (TW)

Correspondence Address: BACON & THOMAS, PLLC, 625 SLATERS LANE, FOURTH FLOOR, ALEXANDRIA, VA, 22314-1176, US

(73) Assignee: Inventec Multimedia & Telecom Corporation, Taipei (TW)

(21) Appl. No.: 12/453,411

(22) Filed: May 11, 2009

(51) Int. Cl. G01N 21/84

(52) U.S. Cl. 356/73.1

(57) ABSTRACT

The specification discloses test device, system, and method for optic fiber cable connections. A light-emitting element emits a light signal, and a light-receiving element receives the light signal. When no electrical signal is received within a predetermined time, the central processing unit generates a random delay time for the light-emitting element to wait for the random delay time before re-emitting the light signal for a connection test. The invention solves the problem of difficulty in locating wrong corrections of optic fiber cables. It can quickly check whether the optic fiber cables are correctly connected.

### BACKGROUND OF THE INVENTION

1. Field of Invention

The invention relates to a test device, system, and method. In particular, the invention relates to a test device, system, and method for optic fiber cable connections.

2. Related Art

The usage of the Internet grows exponentially. It is thus an important objective to increase the speed and flux of the transmission medium. Among all proposals, the optical network receives the most attention because of its large bandwidth, high transmission quality, multiple service compatibility, and low maintenance fees.

Optical fiber cables are the primary transmission medium of the optical network. Normally, the optical fiber cable is split into a first receiving terminal and a first transmitting terminal in a first machine room. The first receiving terminal and the first transmitting terminal are then connected with a second receiving terminal and a second transmission terminal in a second machine room, respectively. Afterwards, the second receiving terminal and the second transmitting terminal are then connected with a third receiving terminal and a third transmission terminal in a second machine room, respectively. Under normal conditions, the optical fiber cables between the receiving terminals should be connected, and so that the optical fiber cables between the transmitting terminals. Thus, the optical network can be used for communications.

Starting from an optical line terminal (OLT) via an optical network unit (ONU) to a destination, the optical network has to pass a large number of machine rooms. It is not an easy task to correctly connect the optical fiber cables in the machine rooms. The connections can be done only by human determinations and communications. Consequently, it is very common to have wrong corrections. If there is only a single wrong correction, it is easy to detect. However, it is not easy to locate the position of the cross connection in practice. What is worse is if there are an even number of cross connections. Such situations are very difficult to detect, and their locations are impossible to pin down. As shown in FIG. 1, the first receiving terminal 141 and the second receiving terminal 142 that connect optical fiber cables 120 have cross connections in the second machine room 132. Concurrently, the third receiving terminal 143 and the fourth receiving terminal 144 connecting the optical fiber cable also have cross connections in the third machine room 134. Although the communications between the first machine room 130 and the fourth machine room 136 are no affected due to the even number of cross connections, this increases difficulty in future maintenance. Moreover, the increase in network uses is accompanied by an increase in optic fiber cables. As a result, it is difficult to locate the optic fiber cables to be repaired during maintenance. This in turn results in network breakdown or instability.

In summary, the prior art long has the problem of cross connections for the optic fiber cables. It is therefore necessary to provide a solution.

### SUMMARY OF THE INVENTION

In view of the foregoing, the invention provides a test device, system, and method for optic fiber cable connections.

The disclosed test device for optic fiber cable connections includes: a connecting element for the connection with an optic fiber cable; a light-emitting element for emitting a light signal; a photo-coupling element for transmitting the light signal to the optic fiber cable and selecting the light signal of appropriate wavelength when the light signal is incident from the optic fiber cable; a light-receiving element for receiving the light signal selected by the photo-coupling element and converting it into an electrical signal using the photoelectric effect; a central processing unit (CPU) for generating a random delay time when no electrical signal is received within a predetermined time, so that the light-emitting element waits the random delay time before re-emitting the light signal from connection tests; and a light-displaying element for triggering an emission state when the light-emitting element emits the light signal and triggering a receiving state when the CPU receives the electrical signal.

The disclose test system for optic fiber cable connections includes: a first test device for emitting a first light signal and triggering a first emission state and triggering a first receiving state when a second light signal incident from the optic fiber cable is received; and a second test device for connecting to the first test device via the optic fiber cable, emitting the second light signal to the first test device and triggering a second emission state, and triggering a second receiving state when the first light signal incident from the optic fiber cable is received.

The disclosed test method for optic fiber cable connection includes the steps of: emitting a first light signal from a first test device and triggering a first emission state; emitting a second light signal from a second test device and transmitting it via the optic fiber cable to the first test device, and triggering a second emission state, wherein the second test device is connected with the first test device via the optic fiber cable; triggering a first receiving state when the first test device receives the second light signal incident from the optic fiber cable; and triggering a second receiving state when the second test device receives the first light signal incident from the optic fiber cable.

### BRIEF DESCRIPTION OF THE DRAWINGS

The invention will become more fully understood from the detailed description given herein below illustration only, and thus is not limitative of the present invention, and wherein:

FIG. 1 shows that the optic fiber cables in the prior art where the problem of an even number of cross connections occurs;

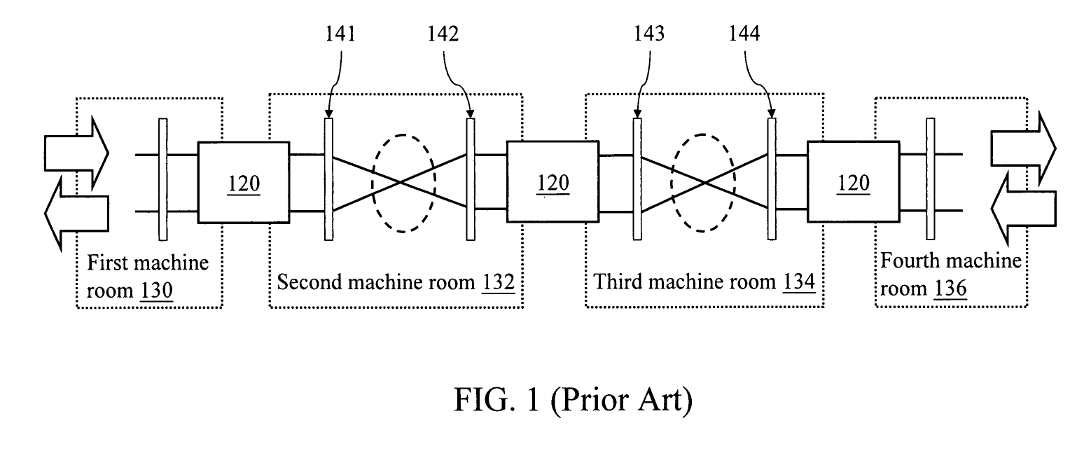

FIG. 2 is a schematic view of elements in the disclosed test device for optic fiber cable connections;

FIG. 3 shows an embodiment of the disclosed test device for optic fiber cable connections;

FIG. 4 is a block diagram of the disclosed test system for optic fiber cable connections;

FIG. 5 is a flowchart of the disclosed test method for optic fiber cable connections; and

FIG. 6 shows the transmissions of light signals in the invention.

### DETAILED DESCRIPTION OF THE INVENTION

The present invention will be apparent from the following detailed description, which proceeds with reference to the accompanying drawings, wherein the same references relate to the same elements.

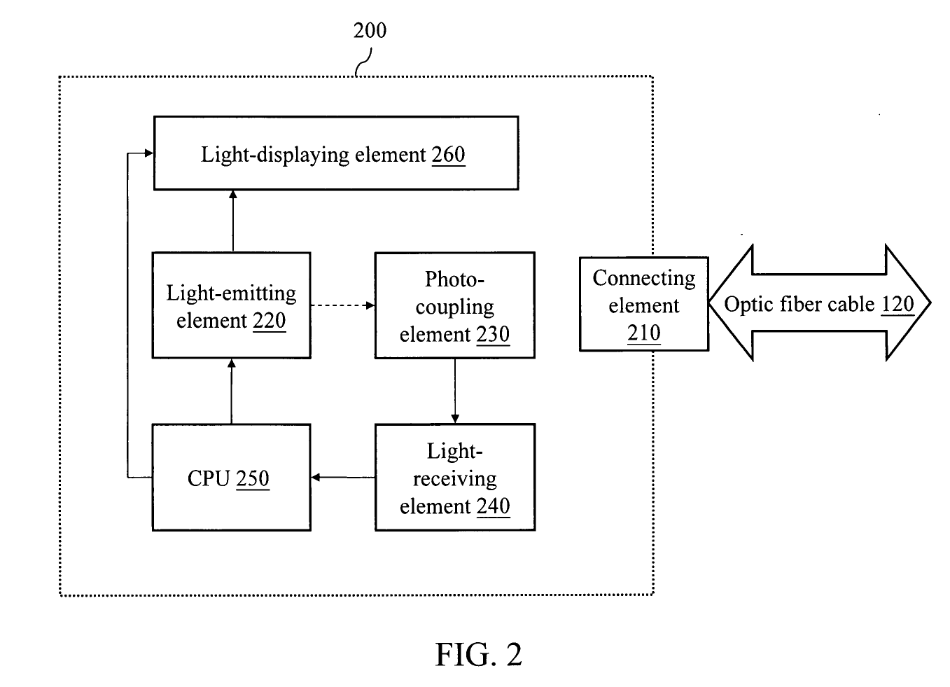

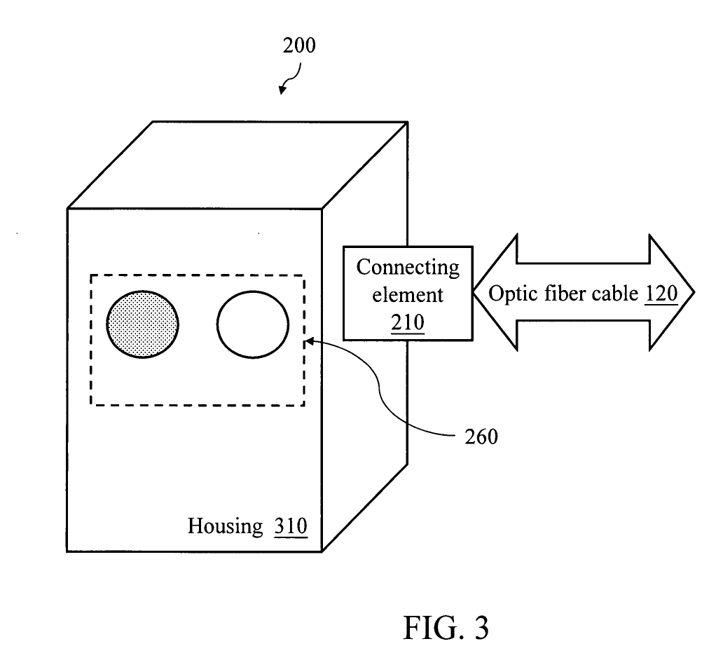

The invention provides test device, system, and method for optic fiber cable connections. The following paragraphs explains the elements in the test device for optic fiber cable connections in FIG. 2, followed by a description of an embodiment shown in FIG. 3.

The test device 200 for optic fiber cable connections according to the invention includes: a connecting element 210, a light-emitting element 220, a photo-coupling element 230, a light-receiving element 240, a central processing unit (CPU) 250, and a light displaying element 260.

The connecting element 210 connects with an optic fiber cable 120 whose function is to transmit a light signal. The optic fiber cable 120 is a single optic fiber that is simplex in one wavelength and can transmit signals in both directions.

The light-emitting element 220 emits a light signal. It can be a laser diode, for example.

The photo-coupling element 230 transmits the light signal emitted from the light-emitting element 220 to the optic fiber cable 120. It also selects the light signal of appropriate wavelength when there is an incident light signal from the optic fiber cable 120. Possible wavelengths of the light signal include 1310 nm, 1490 nm, 1550 nm, and 1625 nm. The invention does not further restrict the wavelength of the light signal. At the same time, the photo-coupling element 230 can select light signals of a specific wavelength from the optic fiber cable 120.

Beside, the photo-coupling element 230 connects to the light-emitting device 220 and the light-receiving element 240, so that the light-emitting device 220 and the light-receiving element 240 are electrically insulated. In addition to electrically insulating between receiving the light signal and emitting the light signal, the photo-coupling element 230 further has the advantages of small size, light weight, and a single direction in light signal transmissions. Therefore, the emitted light signal does not affect the received light signal at all.

The light-receiving element 240 receives the light signal selected by the photo-coupling element 230, and converts the light signal into an electrical signal using the photoelectric effect. The light-receiving element 240 can be a photo diode, for example.

It should be mentioned that the light signal received by the light-receiving element 240 is incident from the optic fiber cable 120. The photo-coupling element 230 selects a light signal of appropriate wavelength, which is not the light signal emitted by the light-emitting element 220.

If the CPU 250 does not receive the electrical signal, it means that there may be light signal collisions, or disorder in the optic fiber cables 120, or breakdown of the light-receiving element 240. Generally speaking, the most common case is light signal collisions. The light signal collision problem has to be solved before the light-receiving element 240 can successfully receive the light signal.

When the CPU 250 does not receive the electrical signal converted from the light signal by the light-receiving element 240 within a predetermined time, it generates a random delay time that is used to delay the light signal emission time of the light-emitting element 220 for further connection tests. The random delay time can be determined using the Binary Exponential Backoff Algorithm, for example. But the invention is not limited to this particular case. If light signal collisions keep happening (i.e., the CPU 250 does not receive any electrical signal at all), then the invention can use the Binary Exponential Backoff Algorithm to increase the required random delay time. This can reduce the light signal collisions for the light signal to propagate smoothly.

The light-displaying element 260 triggers an emission state when the light-emitting element 220 emits the light signal. When the CPU 250 receives the electrical signal, the light-displaying element 260 triggers a receiving state. The light-displaying element 260 can be a light-emitting diode (LED), for example.

FIG. 3 shows an embodiment of the disclosed test device for optic fiber cable connections.

The disclosed test device 200 for optic fiber cable connections can test whether the optic fiber cables 120 are correctly connected. As shown in FIG. 3, for reducing the moisture and convenience in carrying, the disclosed test device 200 further includes a housing 310. The light-emitting element 220, the photo-coupling element 230, the light-receiving element 240, and the CPU 250 are all disposed in the housing 310. For the convenience of determining whether the optic fiber cables 120 are correctly connected, the light-displaying element 260 is disposed on the surface of the housing 310.

In this embodiment, the light-displaying element 260 is an LED as an example. The emission state is represented by red light and the receiving state by green light, for example. However, the invention is not limited to this particular case. When the light-emitting element 220 emits a light signal, the light-displaying element 260 is triggered to emit red light. When the CPU 250 receives an electrical signal, the light-displaying element 260 is triggered to emit green light.

As the emission state (red light) and the receiving state (green light) of the light-displaying element 260 are triggered successively, one can understand whether the optic fiber cables 120 are correctly connected.

In this embodiment, the connecting element 210 is on the right side of the housing 310 of the disclosed test device 200 for optic fiber cable connections. However, its location is not limited to this particular example. The connecting element 210 can be disposed inside the housing 310. The invention does not have any restriction on its location. The test device 200 shown in FIG. 3 is only one embodiment of the invention, and should not be used to restrict the scope of the invention.

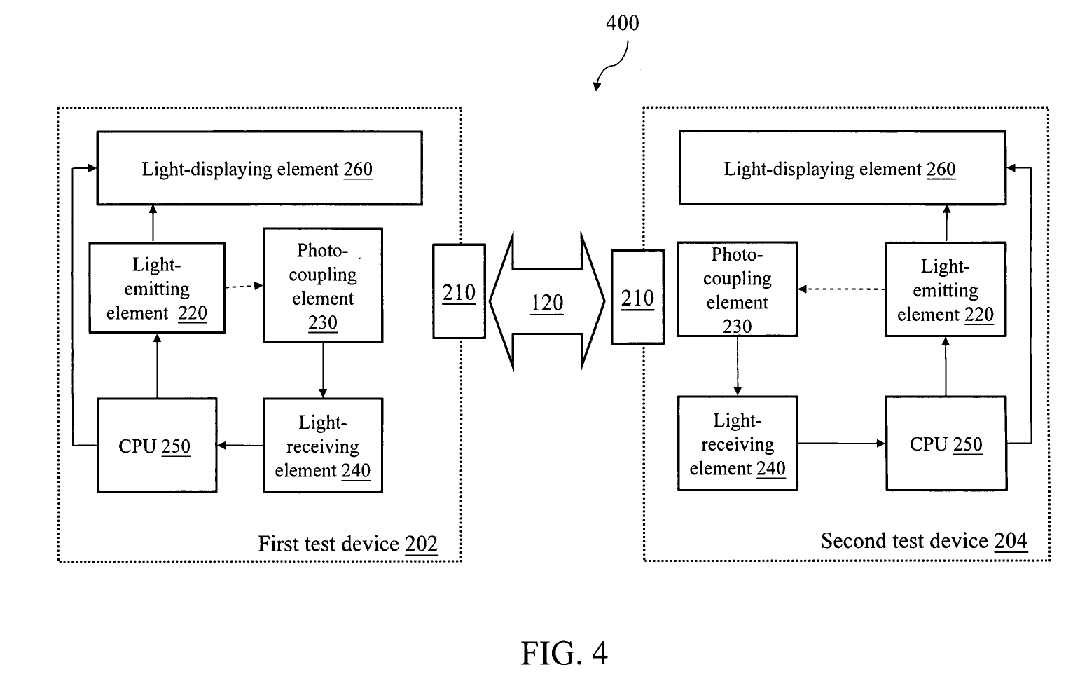

Please refer to FIG. 4, which is a block diagram of the disclosed test system for optic fiber cable connections.

The test system 400 for optic fiber cable connections consists of two of the test devices 200 for optic fiber cable connections connecting to both ends of the optic fiber cable 120 via their own connecting elements 210. The two test devices 200 for optic fiber cable connections are called the first test device 202 and the second test device 204 hereinafter.

The first test device 202 emits a first light signal. Once the first light signal is emitted, it triggers a first emission state. When a second light signal incident from the optic fiber cable is received, it triggers a first receiving state.

The second test device 204 connects to the first test device 202 via the optic fiber cable 120. It emits the second light signal to the first test device 202. After emitting the second light signal, it triggers a second emission state. After receiving the first light signal incident from the optic fiber cable 120, it triggers a second receiving state.

When the light-displaying elements 260 are LED's, the first/second emission states can be represented by red light and the first/second receiving states by green light. The invention is not restricted to this particular choice. In practice, suppose the optic fiber cable 120 is correctly connected (e.g., the optic fiber cables 120 on the receiving end are interconnected, and the optic fiber cables 120 on the transmitting end are interconnected too). If the light-emitting element 220 continuously emits light signals, one sees that the light-displaying elements 260 switch between the emission state and the receiving state incessantly (red to green or green to red) when there is no light signal collision. This is because the propagation speed of the light signals is very fast.

If the optic fiber cable 120 is not correctly connected, then the light-displaying element 260 of the first test device 202 may stay in the first emission state (e.g., red light) or the first receiving state (e.g., green light). Alternatively, the light-displaying element 260 of the second test device 204 may stay in the second emission state (e.g., red light) or the second receiving state (e.g., green light).

Therefore, the test system 400 for optic fiber cable connections can readily determine whether the optic fiber cable 120 is correctly connected by observing the state switches from the light-displaying element 260 of the first test device 202 and the light-displaying element 260 of the second test device 204. This easily achieves the goal of checking whether the optic fiber cable 120 has been correctly connected.

The first test device 202 and the second test device 204 are connected via the optic fiber cable 120. If both of them emit the first light signal and the second light signal, respectively, the light signals may have collisions during the transmission.

When light signal collisions happen, i.e., when the first test device 202 and the second test device 204 concurrently transmit the first light signal and the second light signal, respectively, the first test device 202 and the second test device 204 do not receive the first electrical signal and the second electrical signal, respectively, within a predetermined time. In this case, the first test device 202 automatically generates a random delay time to emit the first light signal for tests again. Likewise, the second test device 204 also automatically generates a random delay time to emit the second light signal for tests again. The random delay time is determined using the Binary Exponential Backoff Algorithm. However, the invention is not limited to this particular example.

Now the first test device 202 and the second test device 204 have to wait their respective random delay times, determined by the Binary Exponential Backoff Algorithm. So the two random delay times are very unlikely to be the same. Thus, when the first test device 202/the second test device 204 re-emit the first light signal/second light signal, the collision probability is greatly reduced. In this case, the first light signal and the second light signal can be successfully sent out. If collisions happen again, the Binary Exponential Backoff Algorithm is employed again to determine the random delay times.

It is worth mentioning that the purpose of the random delay times of the first test device 202 and the second test device 204 is to avoid light signal collisions. However, they are only a few milliseconds, which users would not notice.

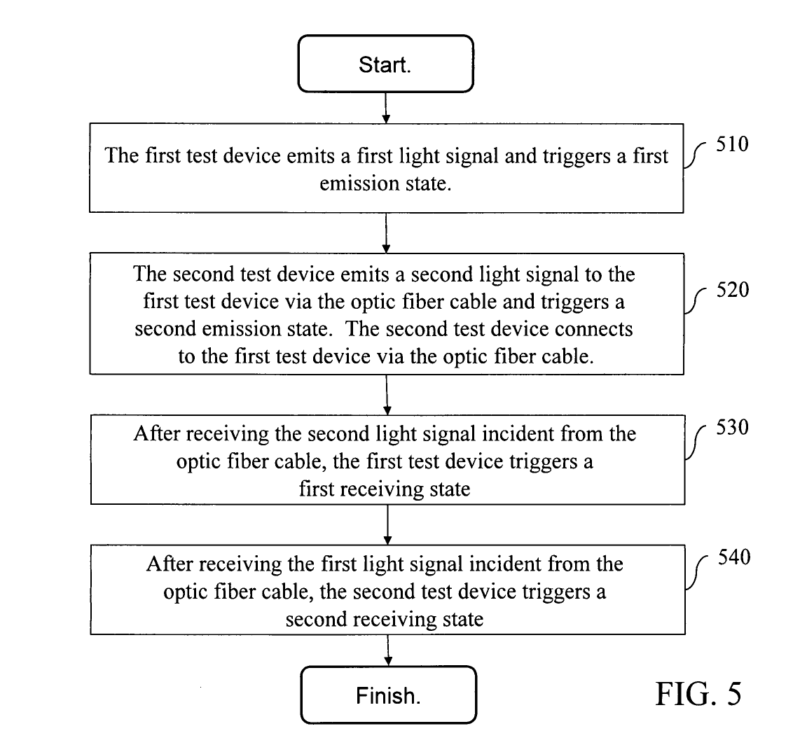

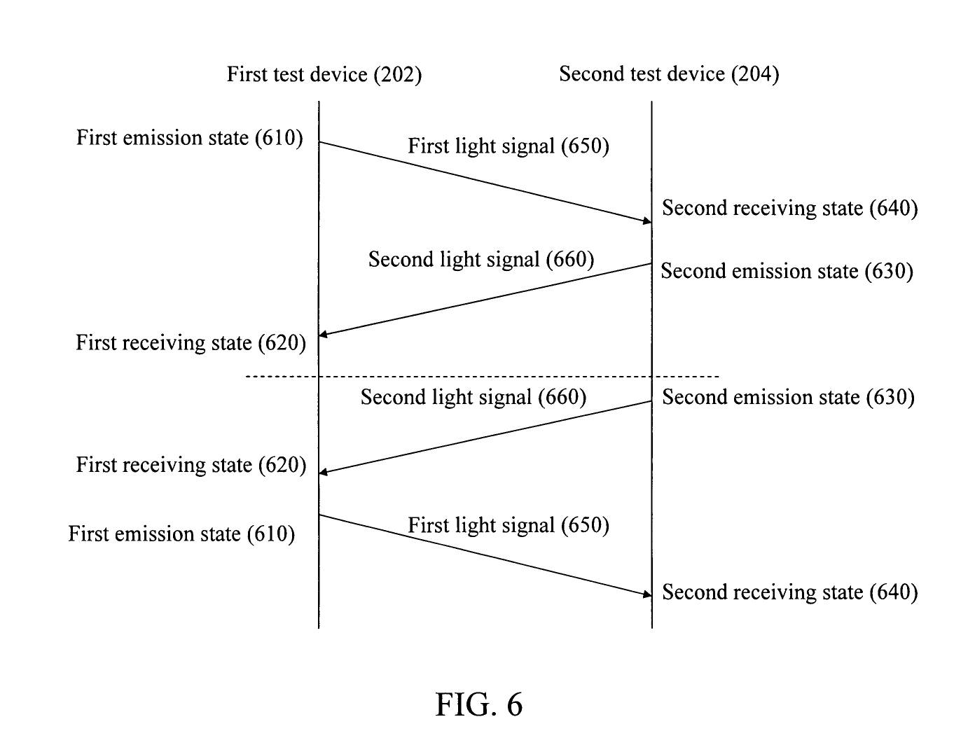

Please refer to FIG. 5 for a flowchart of the disclosed test method for optic fiber cable connections. It is elucidated with an embodiment. Please also refer to FIG. 6 that illustrates the light signal transmissions.

To achieve the objective of quickly determine whether the optic fiber cable 120 is correctly connected, the disclosed method uses two of the test devices 200 for optic fiber cable connections, both connected to the two ends of an optic fiber cable 120. The procedure of the method is as follows.

In step 510, the first test device 202 emits a first light signal 650 and triggers a first emission state 610.

In step 520, the second test device 204 emits a second light signal 660 to the first test device 202 via the optic fiber cable 120 and triggers a second emission state 630. The second test device 204 connects to the first test device 202 via the optic fiber cable 120.

In step 530, after receiving the second light signal 660 incident from the optic fiber cable 120, the first test device 202 triggers a first receiving state 620.

In step 540, after receiving the first light signal 650 incident from the optic fiber cable 120, the second test device 204 triggers a second receiving state 640.

For the convenience of explanation, we suppose the light-displaying elements 260 of the first test device 202 and the second test device 204 are both LED's. The first emission state 610 and the second emission states are represented by red light. The first receiving state 620 and the second receiving state are represented by green light. The invention, however, is not restricted by this particular choice.

As shown in the upper half above the dashed line in FIG. 6, the first test device 202 first emits the first light signal 650 when there is no light signal collision.

When the first test device 202 emits the first light signal 650 and triggers the first emission state 610, the second test device 204 receives the first light signal 650 because there is no light signal collision, thereby triggering the second receiving state 640. Afterwards, without any light signal collision, the second test device 204 emits the second light signal 660 and triggers the second emission state 630. The first test device 202 receives the second light signal 660. Therefore, the light-displaying element 260 of the first test device 202 switches from the first emission state 610 to the first receiving state 620. This means that the optic fiber cable 120 is correctly connected, without any cross connection.

Likewise, in the lower half below the dashed line in FIG. 6, the second test device 204 first emits the second light signal 660 when there is no light signal collision.

When the second test device 204 emits the second light signal 660 and triggers the second emission state 630, the first test device 202 receives the second light signal 660 because there is no light signal collision, thereby triggering the first receiving state 620. Afterwards, without any light signal collision, the first test device 202 emits the first light signal 650 and triggers the first emission state 610. The second test device 204 receives the first light signal 650. Therefore, the light-displaying element 260 of the second test device 204 switches from the second emission state 630 to the second receiving state 640. This means that the optic fiber cable 120 is correctly connected, without any cross connection.

Now suppose the first test device 202 and the second test device 204 are connected to both ends of the optic fiber cable 120, and they simultaneously emit the first light signal 650 and the second light signal 660. The light-displaying elements 260 are LED's, for example. Since the first test device 202 and the second test device 204 can normally emit/receive the light signals, the user can observe the switches between the emission state and the receiving state from the light-displaying elements 260, thereby determining whether the optic fiber cable 120 is correctly connected. This achieves the objective of quickly checking the connection of the optic fiber cable 120.

Suppose a light signal collision happens, i.e., when the first test device 202 and the second test device 204 simultaneously transmit the first light signal 650 and the second light signal 660. In this case, the first test device 202 does not receive the first electrical signal within the predetermined time. Likewise, the second test device 204 does not receive the second electrical signal within the predetermined time, either. The first test device 202 then automatically generates a random delay time for re-emitting the first light signal 650 for connection tests. Likewise, the second test device 204 automatically generates a random delay time for re-emitting the second light signal 660 for connection tests. The random delay times are determined using the Binary Exponential Backoff Algorithm. The invention, however, is not restricted to this particular algorithm.

In summary, the invention differs from the prior art in the following aspects. The invention uses light-emitting elements to emit light signals and light-receiving elements to receive light signals. If no electrical signal is received within a predetermined time, the CPU generates a random delay time for the light-emitting elements to wait and re-emit the light signals for connection tests. The disclosed technique can be used to easily locate where a cross connection occurs, faster than the prior art. Therefore, the invention can quickly check whether the optic fiber cable is correctly connected.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A test device for optic fiber cable connections, comprising:
a connecting element for the connection with an optic fiber cable;
a light-emitting element for emitting a light signal;
a photo-coupling element for transmitting the light signal to the optic fiber cable and selecting the light signal with appropriate wavelength when the light signal is incident from the optic fiber cable;
a light-receiving element for receiving the light signal selected by the photo-coupling element and converting it into an electrical signal using the photoelectric effect;
a central processing unit (CPU) for generating a random delay time when no electrical signal is received within a predetermined time, so that the light-emitting element waits the random delay time before re-emitting the light signal for connection tests; and
a light-displaying element for triggering an emission state when the light-emitting element emits the light signal and triggering a receiving state when the CPU receives the electrical signal.

2. The test device for optic fiber cable connections according to claim 1, wherein the light-emitting element is a laser diode.

3. The test device for optic fiber cable connections according to claim 1, wherein the light-receiving element is a photo diode.

4. The test device for optic fiber cable connections according to claim 1, wherein the random delay time is determined using the Binary Exponential Backoff Algorithm.

5. The test device for optic fiber cable connections according to claim 1, wherein the CPU does not receive the electrical signal because there is a light signal collision.

6. The test device for optic fiber cable connections according to claim 1, wherein the light-displaying element is a light-emitting diode (LED).

7. The test device for optic fiber cable connections according to claim 1 further comprising a housing, wherein the photo-coupling element, the light-receiving element, the light-emitting element, and the CPU are disposed in the housing and the light-displaying element and the connecting element are disposed on the outer surface of the housing.

8. A test system for optic fiber cable connections, comprising:
a first test device, which emits a first light signal and triggers a first emission state and triggers a first receiving state when receiving a second light signal incident from an optic fiber cable; and
a second test device, which connects to the first test device via the optic fiber cable, emits the second light signal to the first test device and triggers a second emission state, and triggers a second receiving state when receiving the first light signal incident from the optic fiber cable.

9. The test system for optic fiber cable connections according to claim 8, wherein when the first test device/the second test device does not receive a first electrical signal/a second electrical signal within a predetermined time the first test device/the second test device wait a random delay time before re-emitting the first light signal/the second light signal for connection tests.

10. The test system for optic fiber cable connections according to claim 9, wherein the random delay time is determined using the Binary Exponential Backoff Algorithm.

11. A test method for optic fiber cable connections, comprising the steps of:
emitting a first light signal from a first test device and triggering a first emission state;
emitting a second light signal from a second test device via a optic fiber cable to the first test device and triggering a second emission state, wherein the second test device connects to the first test device via the optic fiber cable;
triggering a first receiving state when the first test device receives the second light signal incident from the optic fiber cable; and
triggering a second receiving state when the second test device receives the first light signal incident from the optic fiber cable.

12. The test method for optic fiber cable connections according to claim 11 further comprising the step of waiting a random delay time and re-emitting the first light signal/the second light signal when the first test device/the second test device does not receive a first electrical signal/a second electrical signal within a predetermined time.

13. The test method for optic fiber cable connections according to claim 12, wherein the random delay time is determined using the Binary Exponential Backoff Algorithm.
